(19) United States
(12) Patent Application Publication
(10) Pub. No.: US 2024/0223986 A1
(43) Pub. Date: Jul. 4, 2024

(54) DIRECTIONAL SOUND EMISSION METHOD, DEVICE AND APPARATUS

(71) Applicant: Lenovo (Beijing) Limited, Beijing (CN)

(72) Inventors: Yue ZHANG, Beijing (CN); Ran WANG, Beijing (CN); Yang LIU, Beijing (CN)

(21) Appl. No.: 18/529,895

(22) Filed: Dec. 5, 2023

(30) Foreign Application Priority Data
Dec. 30, 2022 (CN) 202211724519.5

(51) Int. Cl. H04S 7/00; H04R 1/32

(52) U.S. Cl. CPC H04S 7/303; H04R 1/323; H04R 2499/15; H04S 2400/11; H04S 2400/13

(57) ABSTRACT

A directional sound emission method including: obtaining position information of a target object which is an object that receives a target sound output by a directional sound emission device; and configuring sound emission parameters of a sound emission component of the directional sound emission device based on the position information, to directionally transmit the target sound to the target object based on the sound emission parameters. The corresponding sound emission parameters when the target object is located in different positions relative to the directional sound emission device are different.

### CROSS-REFERENCE TO RELATED APPLICATION

This application claims priority to Chinese Patent Application No. 202211724519.5, filed on Dec. 30, 2022, the entire content of which is incorporated herein by reference.

### TECHNICAL FIELD

The present disclosure generally relates to the field of electronic technologies and, more particularly, to a directional sound emission method, device, and apparatus.

### BACKGROUND

Online meetings and calls are becoming more and more common in daily life. To minimize impact on others in public spaces or offices, it is always necessary to wear headphones during calls. Over time, it will cause irreversible damage to the ears. Directional sound emission technology in open spaces solves this pain point of users, allowing the users to avoid wearing headphones in shared spaces and reducing the burden on their ears, while ensuring privacy and reducing the impact on others.

### SUMMARY

One aspect of the present disclosure provides a directional sound emission method, including: obtaining position information of a target object which is an object that receives a target sound output by a directional sound emission device; and configuring sound emission parameters of a sound emission component of the directional sound emission device based on the position information, to directionally transmit the target sound to the target object based on the sound emission parameters. The corresponding sound emission parameters when the target object is located in different positions relative to the directional sound emission device are different.

Another aspect of the present disclosure provides a directional sound emission device including an acquisition unit and a configuration unit. The acquisition unit is configured to obtain position information of a target object which is an object that receives a target sound output by a directional sound emission device. The configuration unit is configured to configure sound emission parameters of a sound emission component of the directional sound emission device based on the position information, to directionally transmit the target sound to the target object based on the sound emission parameters. The corresponding sound emission parameters when the target object is located in different positions relative to the directional sound emission device are different.

Another aspect of the present disclosure provides a directional sound emission apparatus including a speaker array and a processor. The processor is configured to: obtain position information of a target object which is an object that receives a target sound output by a directional sound emission device; and configure sound emission parameters of a sound emission component of the directional sound emission device based on the position information, to directionally transmit the target sound to the target object based on the sound emission parameters. The corresponding sound emission parameters when the target object is located in different positions relative to the directional sound emission device are different.

### BRIEF DESCRIPTION OF THE DRAWINGS

FIG. 1 is a flow chart of a directional sound emission method consistent with the present disclosure.

FIG. 2 is a flow chart of another directional sound emission method consistent with the present disclosure.

FIG. 3 is a flow chart of another directional sound emission method consistent with the present disclosure.

FIG. 4 is a schematic structural diagram of a directional sound emission device consistent with the present disclosure.

FIG. 5A is a schematic diagram of a directional sound effect of a speaker array consistent with the present disclosure.

FIG. 5B is a schematic diagram of an implementation of intelligent directional sound effects consistent with the present disclosure.

FIG. 5C is a schematic diagram of another implementation of intelligent directional sound effects consistent with the present disclosure.

FIG. 5D is a flow chart of an implementation of intelligent directional sound effects consistent with the present disclosure.

FIG. 6 is a schematic structural diagram of a directional sound emission apparatus consistent with the present disclosure.

FIG. 7 is a hardware diagram of a directional sound emission device consistent with the present disclosure.

### DETAILED DESCRIPTION OF THE EMBODIMENTS

Hereinafter, embodiments and features consistent with the present disclosure will be described with reference to drawings.

Various modifications may be made to the embodiments of the present disclosure. Thus, the described embodiments should not be regarded as limiting, but are merely examples. Those skilled in the art will envision other modifications within the scope and spirit of the present disclosure.

The accompanying drawings, which are incorporated in and constitute a part of this specification, illustrate embodiments of the present disclosure and, together with the general description of the present disclosure above and the detailed description of the embodiments below, serve to explain the principle of the present disclosure.

These and other features of the present disclosure will become apparent from the following description of non-limiting embodiments with reference to the accompanying drawings.

Although the present disclosure is described with reference to some specific examples, those skilled in the art will be able to realize many other equivalents of the present disclosure.

The above and other aspects, features, and advantages of the present disclosure will become more apparent in view of the following detailed description when taken in conjunction with the accompanying drawings.

Specific embodiments of the present disclosure are hereinafter described with reference to the accompanying drawings. The described embodiments are merely examples of the present disclosure, which may be implemented in various ways. Specific structural and functional details described herein are not intended to limit, but merely serve as a basis for the claims and a representative basis for teaching one skilled in the art to variously employ the present disclosure in substantially any suitable detailed structure.

In the present disclosure, the phrases such as “in one embodiment,” “in another embodiment,” “in yet another embodiment,” or “in other embodiments,” may all refer to one or more of different embodiments in accordance with the present disclosure.

In existing technologies, directional sound speaker technologies often include the following.

The first type is a sound focusing speaker. It is implemented by using a sound concentrator. A speaker in the middle of the sound concentrator plays the sound, and the directional sound effect and the sound focusing are realized in the sound concentrator through the reflection of the sound concentrator. This method is completely based on directional sound technology implemented by physical structures. The advantage of the sound focusing speaker of this solution is that the structure is relatively simple, but the disadvantage includes that it has certain limitations in isolating sound from adjacent areas and it has a relatively bad effect, especially for the low-frequency sound focusing. Moreover, the sound concentrator is bulky, takes up a lot of space, and has different diameters. The size needs to be customized according to the size of the field and the number of people under the cover. At the same time, the range of use of the sound concentrator is greatly limited, and it can only be used under the sound concentrator.

The second type is a directional sound solution based on ultrasound. In this solution, audible sound is modulated on inaudible ultrasound. The self-demodulation characteristics of ultrasound in the air can demodulate the audible sound, and the strong directivity of ultrasound is used to achieve directional sound effect. The directional sound solution based on ultrasound requires an ultrasonic transducer, and then the audible sound modulated on the ultrasound is self-demodulated in the air. Outside the range of the Rayleigh distance, the audible sound is demodulated to achieve the effect of directional sound. Since ultrasound needs to be demodulated for the audible sound in the air, there is a minimum demodulation distance called the Rayleigh distance. This distance is approximately 0.5 meters. Therefore, the directional sound solution based on ultrasound needs to be used outside a range of 0.5 meters, and there are some restrictions on the use scenarios of near-field directional sound. Moreover, the hardware and software of the directional sound solution based on ultrasound need to be redesigned, and the system compatibility is poor. At the same time, the cost of the directional sound solution based on ultrasound is high and the size is large, making it not suitable for personal use.

The present disclosure provides a directional sound emission method. The functions of the method may be realized by a processor in a directional sound emission device executing program codes. The program codes may be stored in a storage medium of the directional sound emission device.

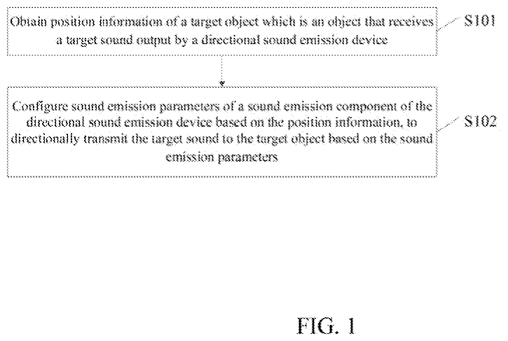

As shown in FIG. 1 which is a flow chart of a directional sound emission method provided by one embodiment of the present disclosure, the method includes S101 and S102.

In S101, position information of a target object is obtained. The target object is an object that receives target sound output from a directional sound emission device.

In the present embodiment, it may be necessary to obtain the position information of the target object (such as a certain user) in the environment where the directional sound emission device is located, that is, the position information of the target object relative to the directional sound emission device. In various embodiments, for example, the position information of the target object may be obtained based on sensors (such as distance sensors, infrared sensors, etc.), and may also be determined based on cameras, radars, or sound source positioning. The sensors, cameras, and other devices may be located on the directional sound emission device.

In some other embodiments, the position information of the target object may also be determined through signal strength, communication parameters, etc. between the directional sound emission device and a wearable device worn by the target object. In some other embodiments, a third-party device may be used to determine the position information of the target object relative to the directional sound emission device.

It should be noted that the embodiments of the present disclosure do not limit the specific implementation manner of obtaining the position information of the target object. For example, in some other embodiments, the target object may also be tracked in real time to obtain the real-time location of the target object.

The directional sound emission device may include a function to provide directional sound to the target object. The directional sound emission device may be any electric device with a speaker array.

In S102, sound emission parameters of a sound emission component of the directional sound emission device are configured based on the position information to directionally deliver the target sound to the target object based on the sound emission parameters.

Target objects in different positions relative to the directional sound emission device may have different sound emission parameters.

The sound emission component of the directional sound emission device may include a digital signal processing (DSP) controller, or may include a speaker array and a DSP controller. The DSP controller may be mainly used for data storage, data processing, filtering, or sampling, etc., and may be equivalent to a simple central processing unit (CPU). The speaker array may include a plurality of speakers.

The sound emission parameters corresponding to the position information of the target object may be configured in the DSP controller, and the target sound may be directionally transmitted to the target object through the speaker array based on the sound emission parameters. It may also be understood that the sound emission parameters of the DSP controller and the speaker array of the directional sound emission device are configured based on the position information of the target object.

In one embodiment, the sound emission parameters of the sound emission component may include, but are not limited to: sound emission direction, amplitude, frequency, period, phase, loudness, wavelength, etc. In some other embodiments, the sound emission parameters may also include a transfer function for directional sound emission or a filter coefficient for realizing directional sound emission.

In some other embodiments, the method may further include at least one of S11 to S13.

In S11, the movement information of the target object is monitored, and the sound emission parameters of the sound emission component of the directional sound emission device are adjusted based on the movement information.

In one embodiment, the movement information of the target object may mainly include the movement speed of the target object or the movement trend of the target object, etc. For example, when the target object is not in a stationary state but in a moving state, the new target area that the target object is about to arrive may be predicted based on the movement trend of the target object, such that the sound emission parameters of the sound emission component of the directional sound emission device may be changed in time to achieve advance adjustment. At the same time, the time when the target object reaches the new target area may also be predicted based on the movement speed of the target object during movement, to accurately determine the time to trigger the parameter adjustment, thereby achieving the purpose of precise adjustment.

In some other embodiments, the motion information may also include other contents, and the present disclosure does not limit this.

In S12, environmental information about the location of the directional sound emission device is obtained, and the sound emission parameters of the sound emission component of the directional sound emission device are adjusted based on the environmental information.

In one embodiment, the environmental information may include environmental noise, and may also include environmental change information, etc.

For example, in one embodiment, when the environmental information at the location of the directional sound emission device is relatively noisy, the sound emission parameters of the sound emission component may be adjusted such that the loudness of the target sound output by the directional sound emission device becomes smaller. When the environmental information at the location of the directional sound emission device is relatively quiet, the sound emission parameters of the sound emission component may be adjusted such that the loudness of the target sound output by the directional sound emission device becomes larger.

In S13, attribute information of the target sound is obtained, and the sound emission parameters of the sound emission component of the directional sound emission device are adjusted based on the attribute information.

In one embodiment, the attribute information of the target sound may include monophonic, dual-channel, audio frame rate, style type, etc. For example, when the style type of the target sound is more passionate, the sound emission parameters of the sound emission component may be adjusted such that the loudness of the target sound output by the directional sound emission device becomes smaller.

In some embodiments, the directional sound emission device may include the speaker array. Correspondingly, the area where the target object is located may be determined and used as the target acoustic bright area. When the area is determined as the target acoustic bright area, the filter coefficient corresponding to each speaker in the speaker array may be determined as the target filter coefficient. Further, the sound to be played may be processed based on the target filter coefficient corresponding to each speaker to obtain the processed sound corresponding to each speaker, and each speaker may be controlled to play the corresponding processed sound at the same time.

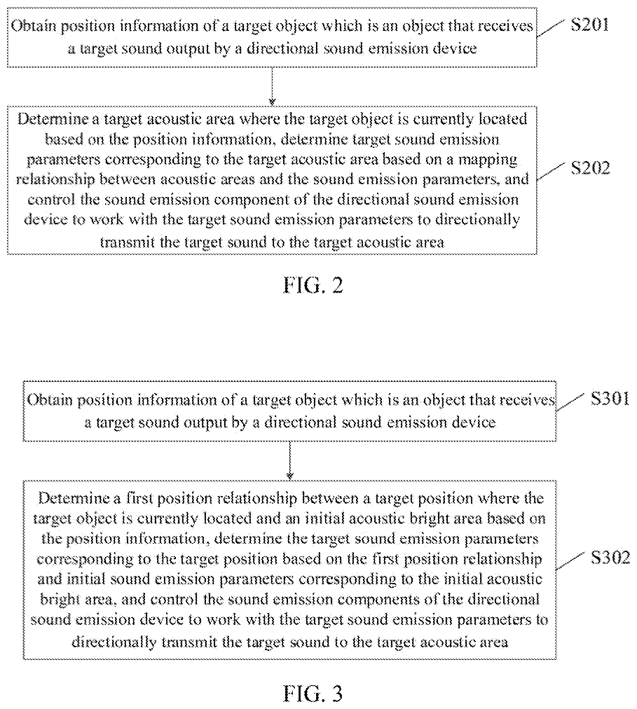

Another embodiment of the present disclosure also provides another directional sound emission method. As shown in FIG. 2, the method may be applied to the directional sound emission device, and includes:
S201: obtaining the position information of the target object, where the target object is an object that receives the target sound output by the directional sound emission device; and
S202: determining a target acoustic area where the target object is currently located based on the position information; determining target sound emission parameters corresponding to the target acoustic area based on a mapping relationship between the acoustic area and the sound emission parameters; and controlling the sound emission component of the directional sound emission device to work with the target sound emission parameters to directionally deliver the target sound to the target acoustic area.

When the target object is in different positions relative to the directional sound emission device, the corresponding sound emission parameters may be different.

In one embodiment, the area contained in the environment where the directional sound emission device is located may be divided into a plurality of acoustic areas, and each acoustic area may have a corresponding sound emission parameter to make the acoustic area being an acoustic bright area and other areas being acoustic dark areas. Therefore, it may be determined which acoustic area of the plurality of acoustic areas the target object is currently in based on the position information of the target object, and the acoustic area may be determined as the target acoustic area. Furthermore, the target sound emission parameters corresponding to the target acoustic area may be determined based on the mapping relationship between the acoustic areas and the sound emission parameters, and then the sound emission component of the directional sound emission device may be controlled to work with the target sound emission parameters to directionally transmit the target sound to the target acoustic area.

For example, the 180-degree area in front of the directional sound emission device may be divided into 10 small areas, and the angle of each area is approximately 18 degrees. Each area may have a preset filter coefficient, to make this area being an acoustic bright area and other areas being acoustic dark areas. When the directional sound emission device obtains the position information of the target object, the directional sound emission device may automatically switch the directional sound area. When the target object is in Area 4, the sound emission component may work with the filter coefficient corresponding to Area 4. At this time, Area 4 may be an acoustic bright area, and other areas may be acoustic dark areas. When the target object moves to Area 1, the DSP controller may automatically switch the filter coefficient corresponding to the directional sound in Area 1. At this time, Area 1 may become an acoustic bright area, and other areas may be acoustic dark areas, thereby achieving the effect of directional sound emission.

Through S201 and S202, the sound emission parameters of the area where the target object is located may be directly switched according to the position of the target object to achieve directional sound emission.

Another embodiment of the present disclosure also provides another directional sound emission method. The method may be applied to the directional sound emission device, and may include S211 to S213

In S211: the position information of the target object may be obtained, where the target object is an object that receives the target sound output by the directional sound emission device; and

In S212: a target acoustic area where the target object is currently located may be determined based on the position information. The sound emission area of the directional sound emission device may be divided into a plurality of acoustic areas. The filter coefficients corresponding to each acoustic area as an acoustic bright area or as an acoustic dark area may be determined, to obtain the mapping relationship between the acoustic areas and the sound emission parameters.

In one embodiment, the area contained in the environment where the directional sound emission device is located may be divided into the plurality of acoustic areas, and each acoustic area may have a corresponding sound emission parameter to make the acoustic area being an acoustic bright area and other areas being acoustic dark areas. Therefore, it may be determined which acoustic area of the plurality of acoustic areas the target object is currently in based on the position information of the target object, and the acoustic area may be determined as the target acoustic area. Furthermore, the target sound emission parameters corresponding to the target acoustic area may be determined based on the mapping relationship between the acoustic areas and the sound emission parameters, and then the sound emission component of the directional sound emission device may be controlled to work with the target sound emission parameters to directionally transmit the target sound to the target acoustic area.

In S213, the target acoustic area where the target object is currently located may be determined as the acoustic bright area. The target filter coefficient corresponding to the acoustic bright area may be determined as the target sound emission parameters based on the mapping relationship, and then the sound emission component of the directional sound emission device may be controlled to work with the target sound emission parameters to directionally transmit the target sound to the target acoustic area.

When the target object is in different positions relative to the directional sound emission device, the corresponding sound emission parameters may be different.

When the target acoustic area where the target object is currently located is used as the acoustic bright area and acoustic areas other than the target acoustic area are used as the acoustic dark areas, the corresponding filter coefficient may be used as the sound emission parameters. Furthermore, the DSP controller and the speaker array of the directional sound emission device may be controlled to operate according to the sound emission parameters, to directionally deliver the target sound to the target acoustic area to achieve a directional sound emission effect. For example, in one embodiment, the speaker array in the directional sound emission device may include four speakers, and the environment in which the directional sound emission device is located may include five areas, namely Area 1, Area 2, to Area 5. When the target object is located in Area 3, the filter coefficients corresponding to the four speakers when Area 3 is an acoustic bright area and other areas are acoustic dark areas may be determined. The DSP controller may use the filter coefficients corresponding to the four speakers to process the sound to be played and obtain four target sounds to be played, such that the four speakers play the corresponding target sounds to be played. These four target sounds to be played may be superimposed on each other in each area, making Area 3 being an acoustic bright area and other areas being acoustic dark areas. In the acoustic dark area, the four target sounds to be played may cancel each other out (that is, the amplitudes are the same and the phases are opposite).

Through S211 to S213, a directional sound emission technology based on acoustic algorithms may be achieved. Compared with the existing ultrasonic directional sound emission technology, the cost may be lower, the low-frequency effect may be better, and it may be more suitable for application scenarios for individual users.

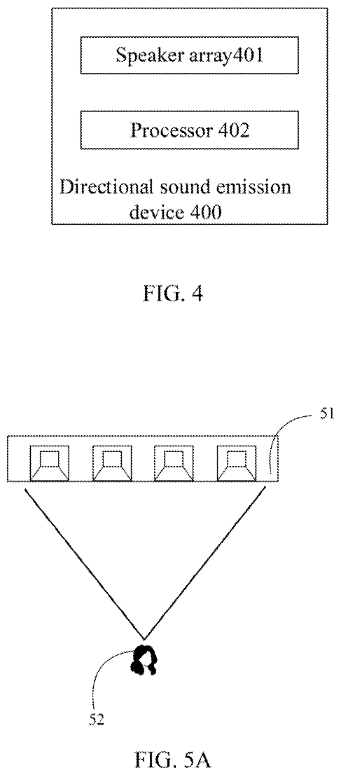

Another embodiment of the present disclosure also provides another directional sound emission method. As shown in FIG. 3, the method may be applied to the directional sound emission device, and includes:
S301: obtaining the position information of the target object, where the target object is an object that receives the target sound output by the directional sound emission device; and
S302: determining a first position relationship between the target position where the target object is located and an initial acoustic bright area according to the position information; determining target sound emission parameters corresponding to the target acoustic area based on the first position relationship and the initial sound emission parameters corresponding to the initial acoustic bright area; and controlling the sound emission component of the directional sound emission device to work with the target sound emission parameters to directionally deliver the target sound to the target acoustic area.

When the target object is in different positions relative to the directional sound emission device, the corresponding sound emission parameters may be different.

In one embodiment, a certain part of the area included in the environment where the directional sound emission device is located may be selected as the initial acoustic bright area, and the initial sound emission parameters corresponding to the initial acoustic bright area may be determined. When the target position of the target object is currently located in the initial acoustic bright area, the sound emission component of the directional sound emission device may be controlled to work with the initial sound emission parameters. When the target position where the target object is currently located is not located in the initial acoustic bright area, the first position relationship between the target position and the initial acoustic bright area (such as an angle formed by the straight line between the directional sound emission device and the target position and the center line of the initial acoustic bright area). The target sound emission parameters may be determined based on the first position relationship and the initial sound emission parameters (for example, the target sound emission parameters may be equal to the initial sound emission parameters multiplied by the above-mentioned angle). Subsequently, the sound emission component of the directional sound emission device may be controlled to work with the target sound emission parameters.

In some other embodiments, in addition to the angle, the first position relationship may also include distance or other types of parameters, and the present disclosure does not limit this.

Through S301 to S302, the target sound emission parameters may be determined based on the positional relationship between the target object and the initial acoustic bright area to achieve directional sound emission.

Another embodiment of the present disclosure also provides another directional sound emission method. The method may be applied to the directional sound emission device, and may include:
S311: obtaining the position information of the target object, where the target object is an object that receives the target sound output by the directional sound emission device; and
S312: determining a first position relationship between the target position where the target object is located and an initial acoustic bright area according to the position information; and determining the position of the initial acoustic bright area and the initial filter coefficients corresponding to the initial acoustic bright area; and
S313: determining an angle transformation matrix based on the first position relationship, processing the initial filter coefficients using the angle transformation matrix to obtain the target filter coefficients, using the target filter coefficients as the target sound emission parameters corresponding to the target position; and controlling the sound emission component of the directional sound emission device to work with the target sound emission parameters to directionally deliver the target sound to the target acoustic area.

The initial filter coefficients corresponding to the initial acoustic bright area may realize the initial sound emission parameters of the initial acoustic bright area. That is, when the target object is located in the initial acoustic bright area, the sound emission component of the directional sound emission device may work with the initial sound emission parameters (such as using the initial filter coefficients to process the sound to be played), such that the target sound is directionally transmitted to the target object. For example, in one embodiment, the range of ±10° of the central axis of the directional sound emission device may be defined as the initial acoustic bright area, and the filter coefficients within this angle range may be preset in the DSP controller as the initial filter coefficients.

When the target object is in different positions relative to the directional sound emission device, the corresponding sound emission parameters may be different.

The angle transformation matrix may be determined based on the first position relationship between the target object and the initial acoustic bright area, and then the initial filter coefficients may be multiplied by the angle change matrix to obtain the target filter coefficients. Furthermore, the target filter coefficients may be used to process the sound to be played to obtain the target sound, thereby achieving a directional sound emission effect. For example, the initial acoustic bright area may be defined and the filter coefficients within the angle range of this area may be preset in the DSP controller as the initial filter coefficients. After obtaining the position information of the target object, the angle of the target object position may be obtained. When the angle is 120 degrees, the initial filter coefficients in the DSP controller may be multiplied by a 120-degree angle transformation matrix to achieve the rotation of the acoustic bright area, thereby achieving a directional sound effect that tracks the position of the object.

Through S311 to S313, a directional sound emission technology based on acoustic algorithms may be achieved. Compared with the existing ultrasonic directional sound emission technology, the cost may be lower, the low-frequency effect may be better, and it may be more suitable for application scenarios for individual users.

In some embodiments, the sound emission component of the directional sound emission device includes at least one speaker array, and the method may further include S31a and S32a.

In S31a, speaker components of the at least one speaker array may be used to sequentially emit white noise, to test the first transfer function of the white noise from the at least one speaker array to the target point position of the acoustically bright area and the second transfer function from the at least one speaker array to the target point position of the acoustically dark area.

In one embodiment, when the at least one speaker array includes the plurality of speakers, the plurality of speakers may be used to emit white noise in sequence, and the first transfer function of the white noise from the corresponding speaker to the target point position in the acoustically bright area and the second transfer function from the corresponding speaker to the target point position in the acoustically dark area may be tested.

In S32a, Based on the first transfer functions and the second transfer functions, the optimal weight vector may be solved with the goal of maximizing the acoustic energy contrast between the acoustic bright area and the acoustic dark area, to obtain the filter coefficients corresponding to each acoustic area.

To implement the method in S211 to S213, it may be necessary to predetermine the filter coefficients for each area as an acoustic bright area. To implement the method in S311 to S313, the filter coefficients of the initial acoustic bright area may need to be determined in advance. Therefore, the filter coefficients may be determined by the method in S31a to S32a described above. By solving the speaker weight vector when the acoustic energy contrast between the acoustic bright area and the acoustic dark area reaches the maximum value, the corresponding filter coefficients when each acoustic area is used as the acoustic bright area and the other areas are used as the acoustic dark areas may be obtained. For the method in S211 to S21, the following contents may need to be tested in the laboratory: Area 1 is an acoustically bright area and other areas are acoustically dark areas; Area 2 is an acoustic bright area and other areas are acoustically dark areas; and so on. Similarly, a number of sets of transfer functions with a number equal to the number of areas obtained by division may need to be tested. For the method in S311 to S313, it may be only necessary to test the transfer function in the laboratory where the initial area is the acoustic bright area and the other areas are the acoustically dark areas. The filter coefficient refers to a variable, and the overall transfer function may change after multiplying by this filter coefficient.

Therefore, the corresponding transfer function may be matched based on the position of the user object based on the speaker array, thereby realizing intelligent dynamic adjustment of the directional sound angle or intelligent dynamic adjustment of the range of the acoustic bright area. A directional sound emission effect that tracks the user's position may be achieved. An effect similar to a “virtual headset” in the area where the user object is located may be achieved.

In some embodiments, S32 where the optimal weight vector may be solved with the goal of maximizing the acoustic energy contrast between the acoustic bright area and the acoustic dark area, to obtain the filter coefficients corresponding to each acoustic area based on the first transfer functions and the second transfer functions may include:
S321: determining a first cross-correlation matrix between the first transfer functions corresponding to different speakers in the speaker array, and a second cross-correlation matrix between the second transfer functions corresponding to different speakers; and
S322: based on the first cross-correlation matrix and the second cross-correlation matrix, solving the optimal weight vector with the goal of maximizing the acoustic energy contrast between the acoustic bright area and the acoustic dark area, to obtain the filter coefficients corresponding to each acoustic area.

For example, in one embodiment,

$${max}_{w} C and C = \frac{{w}^{H} {R}_{b} w}{{w}^{H} ( {R}_{d} + λ I ) w}$$

may be used to determine the filter coefficients corresponding to each acoustic area, where R_{b} is the cross-correlation matrix of the transfer functions G_{b} between the plurality of speakers to the recording devices, R_{d} is the cross-correlation matrix of the transfer functions G_{d} between the plurality of speakers to the acoustic dark areas, w is the weight vector to be solved, and λ is the regularization parameter.

In some embodiments, the method may further include at least one of S31b to S33b.

In S31b, a second position relationship between the target object and the acoustic area target point position of the directional sound emission device may be determined based on the position information, and the sound emission parameters may be adjusted based on the second position relationship.

When obtaining the transfer functions in the above tests, the test distance may be 0.5 meters from the speaker array. That is, a target point (such as a professional artificial headset device or a binaural recording device) may be set 0.5 meters away from the speaker array. The position of the target point may be the acoustic area target point position of the directional sound emission device (the reference position). The sound emission parameters when the area is an acoustic bright area may be also obtained based on this position. When the target object is 0.7 meters away from the speaker array, the difference (i.e., the second position relationship) between the actual position of the target object and the reference position may need to be considered, and the sound emission parameters when the area is an acoustic bright area may be adjusted based on the difference to achieve a more precise directional sound effect.

In S32b, the sensitivity information of the target object to sound may be obtained, and the sound emission parameters may be adjusted based on the sensitivity information.

In one embodiment, user portrait information of the target object, such as user habits, preferences, etc., may also be obtained to infer the sensitivity level information of the target object to sound. degree information, thereby adjusting the sound emission parameters based on the sensitivity level information. For example, when the target object is sensitive to sound, the light emission parameters may be adjusted based on the sensitivity level such that the loudness of the sound is reduced.

In S33b, a third positional relationship between the directional sound emission device and other audio output devices may be obtained, and the sound emission parameters may be adjusted based on the third positional relationship.

In some embodiments, interference from other audio output devices may be considered, and the sound emission parameters may be adjusted based on the positional relationship between the other audio output devices and the directional sound emission device.

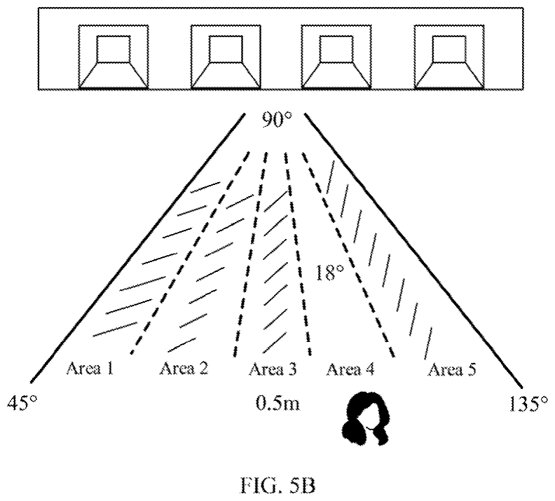

The present disclosure also provides a directional sound emission device. In one embodiment shown in FIG. 4 which is a structural schematic diagram of the directional sound emission device, the directional sound emission device 400 includes:
a speaker array 401; and
a processor 402, configured to: obtain position information of a target object which is an object that receives a target sound output by the directional sound emission device; and configure sound emission parameters of a sound emission component of the directional sound emission device based on the position information, to transmit the target sound directionally to the target object based on the sound emission parameters. When the target object is in different positions relative to the directional sound emission device, the corresponding sound emission parameters are different.

In some embodiments, in addition to the speaker array and the processor, the directional sound emission device may also include a microphone, a Bluetooth interface, a USB interface, function buttons, etc. The microphone may be used to capture a user's position, the Bluetooth and USB interfaces may be used for audio input. The function buttons can include power on, power off, volume adjustment, etc.

In one embodiment, the directional sound emission device may include a plurality of speakers, since the gain coordination between the plurality of speakers is required which also needs to be calculated during experimental testing. The proportion of each speaker's weight vector may be different. For example, one speaker may focus on 200 to 500 HZ (hertz), and another speaker may focus on 1000 to 2000 HZ. This frequency band design may be a way of compensation. Another compensation method is phase compensation. One speaker may only emit in the acoustically bright area, and the other may only emit in the acoustically dark area (that is, emitting two sound signals with the same amplitude and opposite phases which cancel each other out). Moreover, when the target object is located in a certain acoustic bright area, each speaker may correspond to different filter coefficients.

The present disclosure also provides another directional sound emission method and another directional sound emission device. In the present embodiment, the directional sound emission device may use a speaker array including ordinary omnidirectional speaker units, and use a spatial audio control algorithm to realize acoustic bright areas and acoustic dark areas in the space, to achieve the directional sound effect through the contrast between bright and dark areas.

The directional sound speaker array in the directional sound emission device of the present disclosure may use ordinary omnidirectional speaker units. For example, 4 speaker units may form a speaker array structure. In addition to the speaker array, the directional sound emission device may further include: a microphone, a DSP controller, a digital-to-analog conversion device (such as a 4-channel digital-to-analog conversion device), an analog-to-digital conversion device (such as a 1-channel analog-to-digital conversion device), function buttons. power button, battery, a Bluetooth input, or a USB-C(an interface form factor standard) interface input, etc. For example, the signal calculated and output by the DSP controller may be output to the 4 speakers through the 4-channel digital-to-analog conversion device. These 4 speakers may perform audio playback, and their algorithms may all use Wiener filtering. Furthermore, the directional sound of the speakers may be achieved through a preset acoustic algorithm.

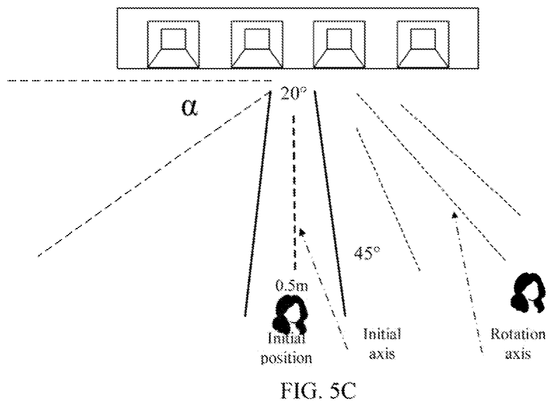

FIG. 5A is a schematic diagram of the directional sound effect of the speaker array in one embodiment of the present disclosure. As shown in FIG. 5, the preset acoustic algorithm may be used to achieve specific differences in the sound emitted by each speaker in the speaker array 51, such that the superposition of the sound emitted by different speakers achieves a directional sound effect in the area where the user 52 is located.

Further, in some embodiments, the user's location may be also tracked while achieving the directional sound effect. The embodiments of the present disclosure provide two methods for intelligent directional sound effects that dynamically track the user's location, thereby achieving the effect of a virtual headset at the user's location.

The first implementation of intelligent directional sound effects.

FIG. 5B illustrates an implementation of intelligent directional sound effects. As shown in FIG. 5B, the speaker array divides the 90° (degree) area in front of the speakers into 5 small areas, with the angle of each area being approximately 18°. Each area has a preset transfer function to make this area being an acoustic bright area and other areas being acoustic dark areas. Therefore, 5 different sets of filter coefficients are preset in the DSP of the speaker array, and each set of coefficients corresponds to the directional sound effect of each area. When the speaker array obtains the user's position information, the speaker array may automatically switch the directional sound area. For example, when the user is in Area 4 and moves to Area 1, the DSP may automatically switch the filter coefficients corresponding to the directional sound in Area 1.

There is no limit on how the user's position information can be obtained in the present disclosure. The user's position information may be obtained through infrared detection, voice distance recognition, etc. The 180° range directly in front of the speakers may be divided into several areas. From left to right, the ranges from 0° to 45° and 135° to 180° may be acoustic dark areas. When the user is in these areas, directional sound cannot be achieved. When the user is in the range of 45° to 135°, the directional sound effect may be achieved. This 90° range may be further subdivided into 5 areas, and the range of each area may be 18°. After the user's position information is input and it is within the range of 45° to 135°, for example, when the user is between 45° and 63°, the filter array may switch to the coefficients of Area 1 preset in the laboratory. Similarly, when a change in the user's position is detected, the DSP may automatically switch the filter coefficients at the corresponding position to achieve a directional sound effect in that direction.

The embodiment here where the divided areas and angles is used as an example only to illustrate the present disclosure, and does not limit the scope of the present disclosure. In the process of actual application, the areas may be divided and the angles of the acoustic bright areas may be defined as needed.

The second implementation of intelligent directional sound effects.

FIG. 5C illustrates an implementation of intelligent directional sound effects. As shown in FIG. 5C, α angle is the included angle of the speaker array, within the 180° range directly in front of the speaker array. The range of ±10° of the central axis of α=90° is the acoustic bright area at the initial position (that is, the angle of the acoustic bright area at the initial position is 20°). At this time, this range is the acoustic bright area, and the filter coefficients within this angle range are preset in the DSP, which is called the filter coefficients at the initial position. After obtaining the user's position information, the angle α₁ of the user's position may be obtained. When α₁=120° at this time, the filter coefficients of the initial position in the DSP may be multiplied by an angle transformation matrix of α₁=120° to achieve the rotation of the acoustic bright area, to achieve a directional sound effect that tracks the user's position.

The purpose of defining the angle of the speaker array is to determine the initial acoustic bright area. The 45° angle in FIG. 5C means that the range of each acoustic bright area is 45 degrees.

The present embodiment with the definition of the angle is used as an example only to illustrate the present disclosure, and does not limit the scope of the present disclosure. In various embodiments, rotations with any other suitable angles are included in the scope of the present disclosure.

### Determining the Sound Emission Parameters:

For the first implementation of intelligent directional sound effects, the following may need to be tested: Area 1 is an acoustic bright area, and the other 4 areas are acoustic dark areas; Area 2 is an acoustic bright area, and the other 4 areas are acoustic dark areas; etc. Similarly, a total of 5 sets of transfer functions may need to be tested. For the first implementation of the intelligent directional sound effects, the transfer functions may need to be tested in the acoustic bright area defined above, with a distance of 0.5 m (meter) away from the speaker array and the angle shown in FIG. 5B.

For the second implementation of intelligent directional sound effects, it may be only necessary to test the transfer function in which the initial position is an acoustic bright area and other positions are acoustic dark areas. For the second implementation of intelligent directional sound effects, the transfer functions may need to be tested in the acoustic bright area defined above, with a distance of 0.5 m (meter) away from the speaker array and the angle shown in FIG. 5C.

For all the transfer functions needed to be tested, the testing process may be same, and may include:
1. L speakers may emit white noise in sequence, and the transfer functions from the speaker units to the target point position in the acoustic bright area may be tested through the microphone. The transfer functions may be denoted as G_{b}.
2. The L speakers may emit white noise in sequence, and the transfer functions from the speaker units to the target point position in the acoustic dark area may be tested through the microphone. The transfer functions may be denoted as G_{d}.
3. The sound energy contrast control algorithm may be used to solve the weight vectors of the L speakers, and 10 log₁₀ C may be defined as the sound energy ratio of the acoustic bright area and the acoustic dark area, where C may be expressed by:

$$C = \frac{{w}^{H} {R}_{b} w}{{w}^{H} ( {R}_{d} + λ I ) w} , \qquad ( 1 )$$

where R_{b} is the cross-correlation matrix of the transfer functions G_{b} between the plurality of speakers to the recording devices, R_{d} is the cross-correlation matrix of the transfer functions G_{d} between the plurality of speakers to the acoustic dark areas, w is the weight vector to be solved, and λ is the regularization parameter.
4. The required sound energy ratio may be obtained by solving the optimal weight vector based on:

$${max}_{w} C . \qquad ( 2 )$$

FIG. 5D is a flow chart of an implementation of the intelligent directional sound effects provided by one embodiment of the present disclosure. As shown in FIG. 5D, both of the two implementations of the intelligent directional sound effects may need position track directional sound speaker array.

The directional sound emission method in the first implementation of the intelligent directional sound effects may include:
S501: testing the transfer functions of Area 1 to Area 5;
S502: obtaining the position information of the user;
S503: matching the filter coefficients of corresponding areas based on the position information and the transfer functions; and
S504: processing audio based on the filter coefficients to achieve directional sound emission of dynamic user position.

The directional sound emission method in the second implementation of the intelligent directional sound effects may include:
S511: testing the transfer function of the initial position;
S512: obtaining the position information of the user, that is, the angle α₁;
S513: obtaining the filter coefficients of corresponding areas based on the angle α₁ and the transfer function; and
S514: processing audio based on the filter coefficients to achieve directional sound emission of dynamic user position.

In the present embodiment, this solution may be implemented based on acoustic algorithms. Compared with ultrasonic directional sound technology, it may be cheaper, have better low-frequency effects, and be more suitable for usage scenarios of individual users. For this speaker array system, the corresponding transfer functions may be matched according to the user's position, thereby realizing intelligent and dynamic adjustment of the directional sound angle, and realizing intelligent and dynamic adjustment of the range of the acoustic bright area. Both of two implementations may effectively achieve these effects, realizing the directional sound effect that tracks the user's position and achieving an effect similar to a “virtual headset” in the user's area.

The present disclosure also provides a directional sound emission apparatus. Units included in the apparatus, modules included in the units, and components included in the modules, may all or partially be implemented by a processor in a directional sound emission device. They may all or partially be implemented by a specific logic circuit. The processor may be a central processing unit (CPU), a microprocessor (MPU), a digital signal processor (DSP), or a field programmable gate array (FPGA), etc.

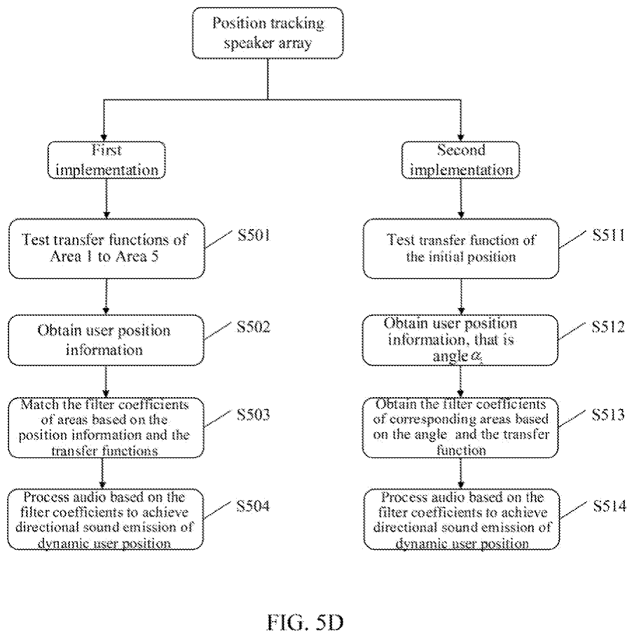

In one embodiment shown in FIG. 6 which is a structural schematic diagram of a directional sound emission apparatus, the apparatus 600 includes:
an acquisition unit 601, configured to obtain the position information of the target object, where the target object is an object that receives the target sound output by the directional sound emission device; and
a configuration unit 602, configured to configure the sound emission parameters of the sound emission component of the directional sound emission device based on the position information, to directly deliver the target sound to the target object based on the sound emission parameters.

In some embodiments, the configuration unit 602 may include at least one of:
a first configuration module, configured to: determine the target acoustic area where the target object is currently located based on the position information, determine the target sound emission parameters corresponding to the target acoustic area based on the mapping relationship between the acoustic areas and the sound emission parameters; and control the sound emission component of the directional sound emission device to work with the target sound emission parameters to directionally deliver the target sound to the target acoustic area; or
a second configuration module, configured to: determine the first position relationship between the target position where the target object is currently located and the initial acoustic bright area based on the position information; determine the target sound emission parameters corresponding to the target position based on the first position relationship and the initial sounding parameters corresponding to the initial acoustic bright area, and control the sound emission component of the directional sound emission device to work with the target sound emission parameters to directionally deliver the target sound to the target acoustic area.

In some embodiments, the first configuration module may include:
a first configuration submodule, configured to: divide the sound emission area of the directional sound emission device into the plurality of acoustic areas; and determine the corresponding filter coefficients of each acoustic area used as an acoustic bright area and as an acoustic dark area, to obtain the mapping relationship between the acoustic areas and the sound emission parameters.

The first configuration submodule may be further configured to use the target acoustic area where the target object is currently located as the acoustic bright area, and use the filter coefficients corresponding to the acoustic bright area as the target sound emission parameters.

In some embodiments, the second configuration module may include:
a second configuration submodule, configured to determine the position of the initial acoustic bright area and the initial filter coefficient corresponding to the initial acoustic bright area.

The second configuration submodule may be further configured to determine an angle transformation matrix based on the first position relationship, process the initial filter coefficient using the angle transformation matrix to obtain the target filter coefficients, and use the target filter coefficients as the target sound emission parameters corresponding to the target position.

In some embodiments, the sound emission component of the directional sound emission device may include at least one speaker array. The apparatus may further include:
a testing unit, configured to use the speaker components of the speaker array to sequentially emit white noise, and test the first transfer functions of the white noise from the speaker array to the target point position in the acoustic bright area and the second transfer functions from the speaker array to the target point position in the acoustic dark area; and
a solving unit, configured to: based on the first transfer functions and the second transfer functions, solve the optimal weight vector with the goal of maximizing the acoustic energy contrast between the acoustic bright area and the acoustic dark area, to obtain the filter coefficients corresponding to each acoustic area.

In some embodiments, the solving unit may include:
a solving subunit, configured to determine a first cross-correlation matrix between the first transfer functions corresponding to different speakers in the speaker array, and a second cross-correlation matrix between the second transfer functions corresponding to different speakers in the speaker array.

The solving subunit may be further configured to: according to the first cross-relation matrix and the second cross-relation matrix, solve the optimal weight vector with the goal of maximizing the acoustic energy contrast between the acoustic bright area and the acoustic dark area, to obtain the filter coefficients corresponding to each acoustic area.

In some embodiments, the apparatus may further include a first adjustment unit or a second adjustment unit.

The first adjustment unit may be configured to monitor motion information of the target object and adjust the sound emission parameters of the sound emission component of the directional sound emission device based on the motion information.

The first adjustment unit may be also configured to obtain the environmental information of the location of the directional sound emission device, and adjust the sound emission parameters of the sound emission components of the directional sound emission device based on the environmental information.

The first adjustment unit may be also configured to obtain the attribute information of the target sound, and adjust the sound emission parameters of the sound emission component of the directional sound emission device based on the attribute information.

The second adjustment unit may be configured to: determine the second position relationship between the target object and the acoustic area target point position of the directional sound emission device based on the position information, and adjust the sound emission parameters based on the second position relationship.

The second adjustment unit may be also configured to obtain the sensitivity information of the target object to sound, and adjust the sound emission parameters based on the sensitivity information.

The second adjustment unit may be also configured to obtain a third position relationship between the directional sound emission device and other audio output devices, and adjust the sound emission parameters based on the third positional relationship.

In some embodiments, the directional sound emission method may be implemented as a software function module which may be sold or used as an independent product. Therefore, it may be stored in a computer readable storage medium. All or part of the steps to implement the above method embodiments may be implemented as a software product, and the software product may be stored in a storage medium and may include instructions for controlling an electronic device (such as a personal computer or a server, etc) to execute all or part of the above methods. The aforementioned storage media may include: flash disks, removable storage devices, ROMs, magnetic disks, optical disks or other media that can store program codes.

The present disclosure also provides a directional sound emission device, including a memory and a processor. The memory may be configured to a computer program that is able to be executed in the processor, and the processor may be configured to execute the computer program to execute all or part of the above directional sound emission methods.

The present disclosure also provides a readable storage medium, configured to store a computer program. The computer program may be executed in a processor, to execute the computer program to execute all or part of the above directional sound emission methods.

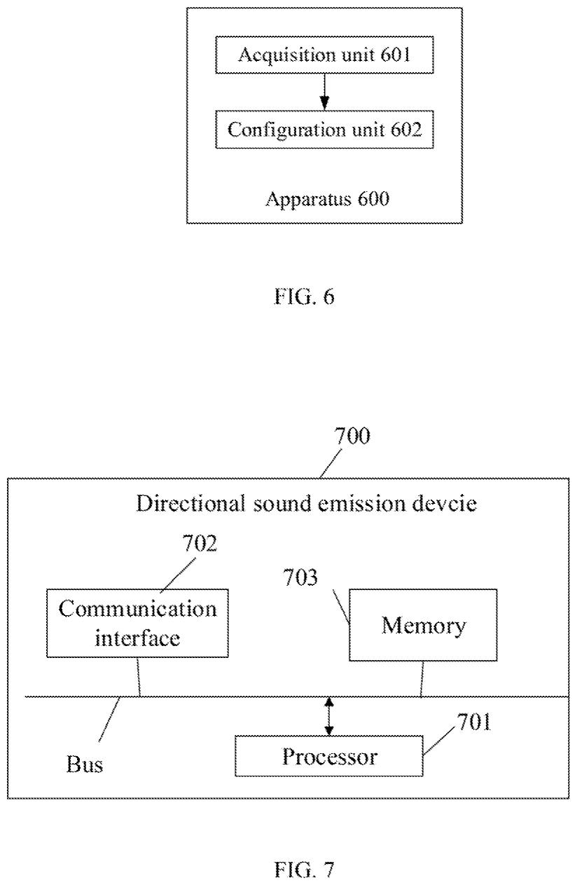

FIG. 7 is a schematic diagram of a hardware structural schematic diagram of a directional sound emission device. As shown in FIG. 7, the hardware structure of the directional sound emission device 700 includes: a processor 701, a communication interface 702, and a memory 703.

The processor 701 is usually configured to control overall operation of the directional sound emission device 700.

The communication interface 702 is configured to enable the directional sound emission device 700 to communicate with other electronic devices or servers or platforms through a network.

The memory 703 is configured to store instructions or applications executable by the processor 701, and may be also configured to cache data to be processed or processed by the processor 701 and each module in the directional sound emission device 700 (for example, image data, audio data, voice communication data and video communication data). The memory 703 may be implemented through FLASH (flash memory) or RAM (Random Access Memory).

Each embodiment in this specification is described in a progressive mode, and each embodiment focuses on the difference from other embodiments. Same and similar parts of each embodiment may be referred to each other. As for the device disclosed in the embodiments, since it corresponds to the method disclosed in the embodiments, the description is relatively simple, and for relevant details, the reference may be made to the description of the method embodiments.

Units and algorithm steps of the examples described in conjunction with the embodiments disclosed herein may be implemented by electronic hardware, computer software or a combination of the two. To clearly illustrate the possible interchangeability between the hardware and software, in the above description, the composition and steps of each example have been generally described according to their functions. Whether these functions are executed by hardware or software depends on the specific application and design constraints of the technical solution. Those skilled in the art may use different methods to implement the described functions for each specific application, but such implementation should not be regarded as exceeding the scope of the present disclosure.

In the present disclosure, the drawings and descriptions of the embodiments are illustrative and not restrictive. The same drawing reference numerals identify the same structures throughout the description of the embodiments. In addition, figures may exaggerate the thickness of some layers, films, screens, areas, etc., for purposes of understanding and ease of description. It will also be understood that when an element such as a layer, film, region or substrate is referred to as being “on” another element, it may be directly on the another element or intervening elements may be present. In addition, “on” refers to positioning an element on or below another element, but does not essentially mean positioning on the upper side of another element according to the direction of gravity.

The orientation or positional relationship indicated by the terms “upper,” “lower,” “top,” “bottom,” “inner,” “outer,” etc. are based on the orientation or positional relationship shown in the drawings, and are only for the convenience of describing the present disclosure, rather than indicating or implying that the device or element referred to must have a specific orientation, be constructed and operated in a specific orientation, and therefore cannot be construed as a limitation of the present disclosure. When a component is said to be “connected” to another component, it may be directly connected to the other component or there may be an intermediate component present at the same time.

It should also be noted that in this article, relational terms such as “first” and “second” are only used to distinguish one entity or operation from another entity or operation, and do not necessarily require or imply that there is such actual relationship or sequence between these entities or operations them. Furthermore, the terms “comprises,” “includes,” or any other variation thereof are intended to cover a non-exclusive inclusion, such that an article or device including a list of elements includes not only those elements, but also other elements not expressly listed. Or it also includes elements inherent to the article or equipment. Without further limitation, an element defined by the statement “comprises a . . . ” does not exclude the presence of other identical elements in an article or device that includes the above-mentioned element.

The disclosed equipment and methods may be implemented in other ways. The device embodiments described above are only illustrative. For example, the division of the units is only a logical function division. In actual implementation, there may be other division methods, such as: multiple units or components may be combined, or can be integrated into another system, or some features can be ignored, or not implemented. In addition, the coupling, direct coupling, or communication connection between the components shown or discussed may be through some interfaces, and the indirect coupling or communication connection of the devices or units may be electrical, mechanical, or other forms.

The units described above as separate components may or may not be physically separated. The components shown as units may or may not be physical units. They may be located in one place or distributed to multiple network units. Some or all of the units may be selected according to actual needs to achieve the purpose of the solution of the present disclosure.

In addition, all functional units in the embodiments of the present disclosure may be integrated into one processing unit, or each unit may be separately used as a unit, or two or more units can be integrated into one unit. The above-mentioned integration units can be implemented in the form of hardware or in the form of hardware plus software functional units.

All or part of the steps to implement the above method embodiments may be completed by hardware related to program instructions. The aforementioned program may be stored in a computer-readable storage medium. When the program is executed, the steps including the above method embodiments may be executed. The aforementioned storage media may include: removable storage devices, ROMs, magnetic disks, optical disks or other media that can store program codes.

When the integrated units mentioned above in the present disclosure are implemented in the form of software function modules and sold or used as independent products, they may also be stored in a computer-readable storage medium. Based on this understanding, the technical solutions of the embodiments of the present disclosure in essence or those that contribute to the existing technology may be embodied in the form of software products. The computer software products may be stored in a storage medium and include a number of instructions for instructing the product to perform all or part of the methods described in various embodiments of the present disclosure. The aforementioned storage media may include: random access memory (RAM), read-only memory (ROM), electrical-programmable ROM, electrically erasable programmable ROM, register, hard disk, mobile storage device, CD-ROM, magnetic disks, optical disks, or other media that can store program codes.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. A directional sound emission method comprising:
obtaining position information of a target object, wherein the target object is an object that receives a target sound output by a directional sound emission device; and
configuring sound emission parameters of a sound emission component of the directional sound emission device based on the position information, to directionally transmit the target sound to the target object based on the sound emission parameters,
wherein,
when the target object is located in different positions relative to the directional sound emission device, the corresponding sound emission parameters are different.

2. The method according to claim 1, wherein:
configuring the sound emission parameters of the sound emission component of the directional sound emission device based on the position information to directionally transmit the target sound to the target object based on the sound emission parameters includes at least one of:
determining a target acoustic area where the target object is currently located based on the position information, determining target sound emission parameters corresponding to the target acoustic area based on a mapping relationship between acoustic areas and the sound emission parameters, and controlling the sound emission component of the directional sound emission device to directionally transmit the target sound to the target acoustic area according to the target sound emission parameters;
or
determining a first position relationship between a target position where the target object is currently located and an initial acoustic bright area based on the position information, determining the target sound emission parameters corresponding to the target position based on the first position relationship and initial sound emission parameters corresponding to the initial acoustic bright area, and controlling the sound emission components of the directional sound emission device to directionally transmit the target sound to the target acoustic area according to the target sound emission parameters.

3. The method according to claim 2, wherein determining the target sound emission parameters corresponding to the target acoustic area based on the mapping relationship between the acoustic areas and the sound emission parameters includes:
dividing a sound emission area of the directional sound emission device into a plurality of acoustic areas; determining filter coefficients of each acoustic area when being used as an acoustic bright area and when being used as an acoustic dark area, to obtain the mapping relationship between the acoustic areas and the sound emission parameters; and
using the target acoustic area where the target object is currently located as an acoustic bright area, and determining the target filter coefficients corresponding to the acoustic bright area as the target sound emission parameters based on the mapping relationship.

4. The method according to claim 2, wherein determining the target sound emission parameter corresponding to the target position based on the first position relationship and the initial sound emission parameter corresponding to the initial acoustic bright area includes:
determining the position of the initial acoustic bright area and its corresponding initial filter coefficients;
determining an angle transformation matrix based on the first position relationship, using the angle transformation matrix to process the initial filter coefficients to obtain the target filter coefficients, and using the target filter coefficients as the target sound emission parameters corresponding to the target position.

5. The method according to claim 2, wherein:
the sound emission component of the directional sound emission device includes at least one speaker array; and
the method further includes:
using speakers of the at least one speaker array to emit white noise in sequence, to test first transfer functions of the white noise from the speaker array to a target point position in the acoustic bright area and second transfer functions of the white noise from the speaker array to a target point position in the acoustic dark area; and
determining a weight vector with the goal of maximizing an acoustic energy contrast between the acoustic bright area and the acoustic dark area based on the first transfer functions and the second transfer functions, to obtain the filter coefficients corresponding to each acoustic area.

6. The method according to claim 5, wherein determining the weight vector with the goal of maximizing the acoustic energy contrast between the acoustic bright area and the acoustic dark area based on the first transfer functions and the second transfer functions, to obtain the filter coefficients corresponding to each acoustic area, includes:
determining a first cross-correlation matrix between the first transfer functions corresponding to different speakers in the at least one speaker array, and a second cross-correlation matrix between the second transfer functions corresponding to different speakers; and
based on the first cross-correlation matrix and the second cross-correlation matrix, determining the weight vector with the goal of maximizing the acoustic energy contrast between the acoustic bright area and the acoustic dark area, to obtain the filter coefficients corresponding to each acoustic area.

7. The method according to claim 1, further including at least one of:
monitoring movement information of the target object and adjusting the sound emission parameters of the sound emission component of the directional sound emission device based on the movement information;
or
obtaining environmental information of the position of the directional sound emission device and adjusting the sound emission parameters of the sound emission component of the directional sound emission device based on the environmental information;
or
obtaining attribute information of the target sound and adjusting the sound emission parameters of the sound emission component of the directional sound emission device based on the attribute information.

8. The method according to claim 5, further including at least one of:
determining a second position relationship between the target object and an acoustic area target point position of the directional sound emission device based on the position information, and adjusting the sound emission parameters based on the second position relationship;
or
obtaining sensitivity information of the target object to sound and adjusting the sound emission parameters based on the sensitivity information;
or
obtaining a third position relationship between the directional sound emission device and other audio output devices, and adjusting the sound emission parameters based on the third position relationship.

9. A directional sound emission device, comprising:
an acquisition unit, configured to obtain position information of a target object, wherein the target object is an object that receives a target sound output by a directional sound emission device; and
a configuration unit, configured to configure sound emission parameters of a sound emission component of the directional sound emission device based on the position information, to directionally transmit the target sound to the target object based on the sound emission parameters, wherein the corresponding sound emission parameters when the target object is located in different positions relative to the directional sound emission device are different.

10. A directional sound emission apparatus, comprising:
a speaker array, and
a processor, configured to:
obtain position information of a target object, wherein the target object is an object that receives a target sound output by a directional sound emission device; and
configure sound emission parameters of a sound emission component of the directional sound emission device based on the position information, to directionally transmit the target sound to the target object based on the sound emission parameters, wherein the corresponding sound emission parameters when the target object is located in different positions relative to the directional sound emission device are different.

11. The directional sound emission apparatus according to claim 10, wherein the processor is further configured to:
configure the sound emission parameters of the sound emission component of the directional sound emission device based on the position information to directionally transmit the target sound to the target object based on the sound emission parameters includes at least one of:
determine a target acoustic area where the target object is currently located based on the position information, determining target sound emission parameters corresponding to the target acoustic area based on a mapping relationship between acoustic areas and the sound emission parameters, and controlling the sound emission component of the directional sound emission device to directionally transmit the target sound to the target acoustic area according to the target sound emission parameters;
or
determine a first position relationship between a target position where the target object is currently located and an initial acoustic bright area based on the position information, determining the target sound emission parameters corresponding to the target position based on the first position relationship and initial sound emission parameters corresponding to the initial acoustic bright area, and controlling the sound emission components of the directional sound emission device to directionally transmit the target sound to the target acoustic area according to the target sound emission parameters.

12. The directional sound emission apparatus according to claim 11, wherein the processor is further configured to:
divide a sound emission area of the directional sound emission device into a plurality of acoustic areas; determining filter coefficients of each acoustic area when being used as an acoustic bright area and when being used as an acoustic dark area, to obtain the mapping relationship between the acoustic areas and the sound emission parameters; and
use the target acoustic area where the target object is currently located as an acoustic bright area, and determining the target filter coefficients corresponding to the acoustic bright area as the target sound emission parameters based on the mapping relationship.

13. The directional sound emission apparatus according to claim 11, wherein the processor is further configured to:
determine the position of the initial acoustic bright area and its corresponding initial filter coefficients;
determine an angle transformation matrix based on the first position relationship, using the angle transformation matrix to process the initial filter coefficients to obtain the target filter coefficients, and using the target filter coefficients as the target sound emission parameters corresponding to the target position.

14. The directional sound emission apparatus according to claim 11, wherein:
the sound emission component of the directional sound emission device includes at least one speaker array; and
the processor is further configured to:
use speakers of the at least one speaker array to emit white noise in sequence, to test first transfer functions of the white noise from the speaker array to a target point position in the acoustic bright area and second transfer functions of the white noise from the speaker array to a target point position in the acoustic dark area; and
determine a weight vector with the goal of maximizing an acoustic energy contrast between the acoustic bright area and the acoustic dark area based on the first transfer functions and the second transfer functions, to obtain the filter coefficients corresponding to each acoustic area.

15. The directional sound emission apparatus according to claim 14, wherein the processor is further configured to:
determine a first cross-correlation matrix between the first transfer functions corresponding to different speakers in the at least one speaker array, and a second cross-correlation matrix between the second transfer functions corresponding to different speakers; and
based on the first cross-correlation matrix and the second cross-correlation matrix, determine the weight vector with the goal of maximizing the acoustic energy contrast between the acoustic bright area and the acoustic dark area, to obtain the filter coefficients corresponding to each acoustic area.

16. The directional sound emission apparatus according to claim 10, wherein the processor is further configured to:
monitor movement information of the target object and adjusting the sound emission parameters of the sound emission component of the directional sound emission device based on the movement information;
or
obtain environmental information of the position of the directional sound emission device and adjusting the sound emission parameters of the sound emission component of the directional sound emission device based on the environmental information;
or
obtain attribute information of the target sound and adjusting the sound emission parameters of the sound emission component of the directional sound emission device based on the attribute information.

17. The directional sound emission apparatus according to claim 14, wherein the processor is further configured to:
determine a second position relationship between the target object and an acoustic area target point position of the directional sound emission device based on the position information, and adjusting the sound emission parameters based on the second position relationship;
or
obtain sensitivity information of the target object to sound and adjusting the sound emission parameters based on the sensitivity information;
or
obtain a third position relationship between the directional sound emission device and other audio output devices, and adjusting the sound emission parameters based on the third position relationship.
